(19) United States
(12) Patent Application Publication
(10) Pub. No.: US 2023/0017377 A1
(43) Pub. Date: Jan. 19, 2023

(54) ON-BOARD DEVICE, SERVER, AND AUTONOMOUS DRIVING AVAILABILITY DETERMINATION SYSTEM AND METHOD

(71) Applicant: DENSO CORPORATION, Kariya-city (JP)

(72) Inventor: Hirohisa WATANABE, Kariya-city (JP)

(21) Appl. No.: 17/929,472

(22) Filed: Sep. 2, 2022

Related U.S. Application Data
(63) Continuation of application No. PCT/JP2021/004778, filed on Feb. 9, 2021.

(30) Foreign Application Priority Data
Mar. 3, 2020 (JP) 2020-035781

(51) Int. Cl. G01C 21/36; G01C 21/34; G05D 1/00

(52) U.S. Cl. CPC G01C 21/3697; G01C 21/3407; G05D 1/0088; G05D 2201/0213

(57) ABSTRACT

An on-board device for a vehicle includes an unavailability location determination unit configured to determine whether an area around where the vehicle is traveling is an autonomous driving unavailable location, and a transmission control unit configured to cause the on-board device to transmit to a server a result of determination made by the unavailability location determination unit.

### CROSS-REFERENCE TO RELATED APPLICATION

This application is a continuation application of International Application No. PCT/JP2021/004778 filed Feb. 9, 2021 which designated the U.S. and claims priority to Japanese Patent Application No. 2020-035781 filed Mar. 3, 2020, the contents of each of which are incorporated herein by reference.

### BACKGROUND

### Technical Field

The present disclosure relates to an on-board device, a server, an autonomous driving availability determination system including the on-board device and the server.

### Related Art

In recent years, the autonomous driving technology is becoming increasingly practical. For example, a configuration is known, in which, when autonomous driving is suspended on the vehicle side according to operations by a driver or situations around the vehicle, information on a location where autonomous driving was suspended is to be transmitted to a server.

### BRIEF DESCRIPTION OF THE DRAWINGS

In the accompanying drawings:

FIG. 1 is an overall configuration of an autonomous driving availability determination system according to a first embodiment;

FIG. 2 is an illustration of autonomous driving availability information (Part 1);

FIG. 3 is an illustration of autonomous driving availability information (Part 2);

FIG. 4 is an illustration of autonomous driving availability information (Part 3);

FIG. 5 is a flowchart of a process performed by an on-board device (Part 1);

FIG. 6 is a flowchart of a process performed by a server;

FIG. 7 is an overall configuration of an autonomous driving availability determination system according to a second embodiment;

FIG. 8 is a flowchart of a process performed by an on-board device (Part 2);

FIG. 9 is a flowchart of a process performed by an on-board device (Part 3); and

FIG. 10 is a flowchart of a process performed by an on-board device (Part 4).

### DESCRIPTION OF SPECIFIC EMBODIMENTS

In the above known configuration, as disclosed in JP 2019-40235 A, information on the location where autonomous driving has been suspended is transmitted to the server, thereby causing the server to reflect such information as an autonomous driving unavailable location. However, when unavailability of autonomous driving is removed at the autonomous driving unavailable location, that is, when a state where autonomous driving is available is recovered, such information cannot be transmitted to the server, which can not cause the server to reflect the fact that unavailability of autonomous driving has been removed. As a result, information registered as an autonomous driving unavailable location is not updated on the server, and freshness of the information may become outdated. Under these circumstances, there is a need for a technology for, in response to unavailability of autonomous driving having been removed, causing the server to reflect removal of unavailability of autonomous driving.

In view of the foregoing, it is desired to have a technique, for in response to removal of unavailability of autonomous driving at an autonomous driving unavailable location, properly causing the server to reflect the removal of unavailability of autonomous driving.

According to one aspect of the present disclosure, an unavailability location determination unit is configured to determine whether an area around where a vehicle is traveling is an autonomous driving unavailable location. A transmission control unit is configured to cause an on-board device for the vehicle to transmit to a server a result of determination made by the unavailability location determination unit. As above, a result of determination as to whether an area around where a vehicle is traveling is an autonomous driving unavailable location is configured to be transmitted to a server. In response to determining that the area around where the vehicle is traveling is not an autonomous driving unavailable location, such information is configured to be transmitted to the server, thereby causing the server to appropriately reflect the fact that unavailability of autonomous driving has been removed.

Hereinafter, some embodiments will be described with reference to the accompanying drawings. In each of the embodiments described below, identical reference numerals are used to designate identical elements that are common to the elements described in the preceding embodiments. Duplicated description thereof will be omitted.

### First Embodiment

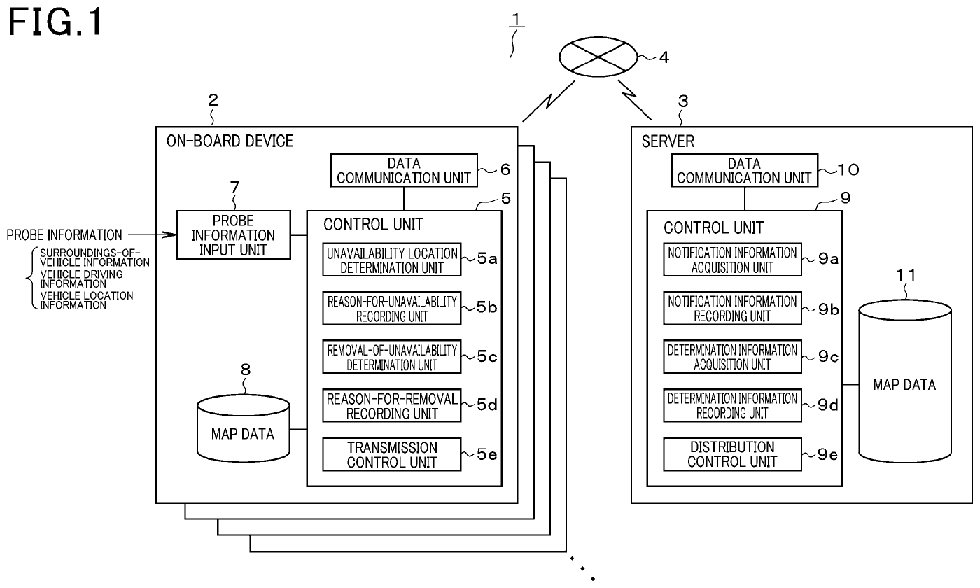

A first embodiment will be described with reference to FIGS. 1 to 6. As illustrated in FIG. 1, the autonomous driving availability determination system 1 includes on-board devices 2 mounted to respective vehicles and a server 3 disposed on the network side. The on-board devices 2 and the server 3 are data-communicably connected to each other via the communication network 4. The on-board devices 2 and the server 3 are in a many-to-one relationship, and the server 3 is capable of communicating data with a plurality of on-board devices 2 via the communication network 4.

Each on-board device 2 includes a control unit 5, a data communication unit 6, a probe information input unit 7, and a map database 8. The map database 8 corresponds to a map data storage unit. The control unit 5 is configured as a microcomputer formed of a central processing unit (CPU), a read-only memory (ROM), a random-access memory (RAM), and an input/output (I/O) interface. The microcomputer executes one or more computer programs stored in a non-transitory tangible storage medium to perform processes corresponding to the computer programs, thereby controlling the overall operation of the on-board device 2.

The data communication unit 6 controls data communication with the server 3 via the communication network 4. The probe information input unit 7 receives surroundings-of-vehicle information, vehicle driving information, and vehicle location information, as probe information. The probe information input unit 7 receives, as the surroundings-of-vehicle information, camera images captured by a forward looking on-board camera, sensor information detected by a sensor that detects objects around the vehicle, radar information detected by a radar that detects objects around the vehicle. The probe information input unit 7 receives, as the vehicle driving information, vehicle speed information detected by a vehicle speed sensor. The probe information input unit 7 receives, as the vehicle location information, positional coordinates measured by GPS signals received from a global positioning system (GPS) receiver. The satellite positioning systems include, but are not limited to the GPS, various global navigation satellite systems (GNSS), such as GLONASS, Galileo, BeiDou, IRNSS and the like.

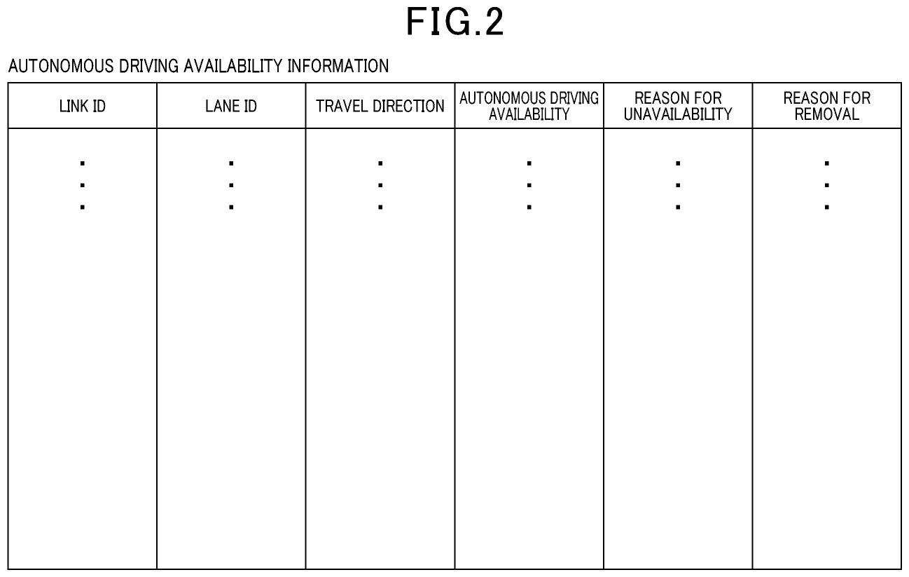

The map database 8 may store map data and may further store autonomous driving availability information in association with the map data. The map database 8 has a relatively small data storage capacity, and the map data stored in the map database 8 is map data covering a narrow area according to a location of an own vehicle. As illustrated in FIG. 2, the autonomous driving availability information includes link IDs for identifying links on the map, lane IDs for identifying lanes, travel directions, autonomous driving availability, reasons for unavailability regarding why the area around where the vehicle is traveling is an autonomous driving unavailable location, and reasons for removal regarding why unavailability of autonomous driving at the autonomous driving unavailable location is removed. In the present embodiment, example cases including both the reason for unavailability and the reason for removal are described. Alternatively, the reason for removal may be omitted because removal of the reason for unavailability means that unavailability of autonomous driving has been removed at an autonomous driving unavailable location. Still alternatively, the reason for unavailability may be omitted because elimination of the reason for removal means that the location where the reason for removal is eliminated is an autonomous driving unavailable location. That is, either the reason for unavailability or the reason for removal may be omitted.

The control unit 5 includes an unavailability location determination unit 5a, a reason-for-unavailability recording unit 5b, a removal-of-unavailability determination unit 5c, a reason-for-removal recording unit 5d, and a transmission control unit 5e. These functional blocks correspond to processes of the autonomous driving availability determination program performed by the microcomputer.

When the probe information input unit 7 receives surroundings-of-vehicle information, such as camera images, sensor information, radar information, the unavailability location determination unit 5a uses the received surroundings-of-vehicle information to determine whether the area around where the vehicle is traveling is an autonomous driving unavailable location. For example, in a case where there is a dropped object or a disabled vehicle is stopped, the unavailability location determination unit 5a determines that the area around where the vehicle is traveling is an autonomous driving unavailable location. The area around where the vehicle is traveling may include not only a lane of travel in which the vehicle is traveling, but also adjacent lanes adjacent to the lane of travel and oncoming lanes in the opposite direction.

In a case where there is a dropped object or a stationary disabled vehicle in the lane of travel in which the vehicle is traveling, the unavailability location determination unit 5a determines that the lane of travel in which the vehicle is traveling is autonomous driving unavailable. In a case where there is a dropped object or a stationary disabled vehicle in an adjacent lane or in an oncoming lane, the unavailability location determination unit 5a determines that the adjacent lane or the oncoming lane is autonomous driving unavailable. That is, the unavailability location determination unit 5a may determine whether autonomous driving is unavailable not only for the lane of travel in which the own vehicle is traveling, but also for adjacent lanes and oncoming lanes.

Factors that may cause autonomous driving unavailable locations include road construction, vehicles parked on the roadside, traffic congestion, traffic accidents, frozen road surfaces, snow on road surfaces, bad weather, paint rubbing on road surfaces, and driver's operations to disable automatic driving, in addition to dropped objects and disabled vehicles. Example cases where autonomous driving availability is determined on a lane-by-lane basis are described here. Alternatively, autonomous driving availability may be determined on a road-by-road basis. The road-by-road basis means a unit of a plurality of lanes with the same direction of travel on a road with a plurality of lanes on one side, or a road itself with only one lane on one side.

Autonomous driving availability may be determined based on whether a predefined condition is met. For example, autonomous driving availability may be determined based on whether the Operational Design Domain (ODD) set for vehicles is met. The ODD includes: a condition (i) that the vehicle is traveling on a highway or a road exclusive for vehicles with two or more lanes in each direction with a median strip, guardrails and the like; a condition (ii) that the distance between the own vehicle and a vehicle preceding or following the own vehicle, traveling in the own-vehicle's lane or an adjacent lane thereto, is small and the vehicle is thus traveling in congested traffic; a condition (iii) that the speed of the own vehicle is at or below 60 kilometers per hour, and a condition (iv) that there are neither traffic signals nor pedestrians in a detection range of on-board sensors, such as millimeter wave radar and Light Detection and Ranging (LiDAR). In the following, as an example, in a case where there is a dropped object in the lane of travel in which the own vehicle is traveling, or in a case where the image recognition performance of the on-board camera is degraded due to backlighting or the like, it may be determined that autonomous driving is unavailable. The condition for determining unavailability of autonomous driving may be changed as necessary. Alternatively, a plurality of conditions may be combined to determine autonomous driving availability.

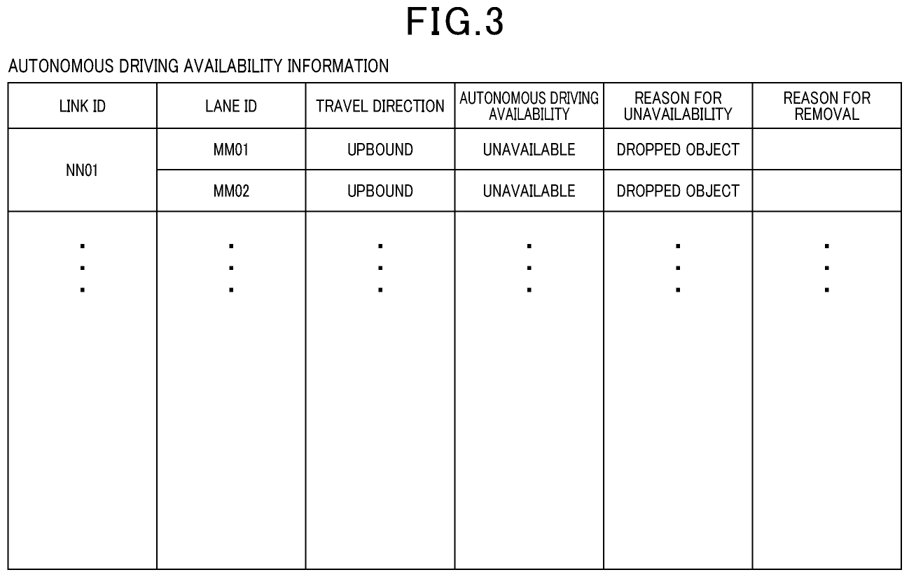

When the unavailability location determination unit 5a determines that the area around where the vehicle is traveling is an autonomous driving unavailable location, the reason-for-unavailability recording unit 5b records the reason for unavailability in association with the autonomous driving unavailable location. That is, as illustrated in FIG. 3, for example, in a case where a location specified by the link ID “NN01” and the lane IDs “MM01” and “MM02” is determined to be autonomous driving unavailable due to the presence of a dropped object, “unavailable” is recorded as the autonomous driving availability and “dropped object” is recorded as the reason for unavailability.

When the reason for unavailability is recorded by the reason-for-unavailability recording unit 5b in association with the autonomous driving unavailable location, the transmission control unit 5e causes the data communication unit 6 to transmit the determination result of the unavailability location determination unit 5a and the reason for unavailability as unavailability notification information to the server 3. The transmission control unit 5e causes the data communication unit 6 to transmit to the server 3 unavailability determination information that was used by the unavailability location determination unit 5a to determine that the area around where the vehicle is traveling is an autonomous driving unavailable location. That is, for example, in a case where the presence of a dropped object is detected from the camera images and the area around where the vehicle is traveling is thus determined to be an autonomous driving unavailable location, the transmission control unit 5e causes the data communication unit 6 to transmit the camera images of the dropped object to the server 3 as the unavailability determination information.

When the probe information input unit 7 receives surroundings-of-vehicle information, such as camera images, sensor information, radar information, the removal-of-unavailability determination unit 5c uses the received surroundings-of-vehicle information to determine whether unavailability of autonomous driving has been removed at the autonomous driving unavailable location, that is, whether the reason for unavailability has been eliminated and whether autonomous driving is available. The removal-of-unavailability determination unit 5c determines that unavailability of autonomous driving has been removed at the autonomous driving unavailable location, for example, when a dropped object that was present has been removed or when a disabled vehicle that was stopped has been removed. The autonomous driving unavailable locations may include not only the lane of travel in which the own vehicle is traveling, but also adjacent lanes adjacent to the lane of travel and oncoming lanes in the opposite direction.

The removal-of-unavailability determination unit 5c determines that unavailability of autonomous driving in the lane of travel has been removed, when a dropped object that was present in the lane of travel has been removed or when a disabled vehicle that was stopped in the lane of travel has been removed. The removal-of-unavailability determination unit 5c determines that unavailability of autonomous driving in the adjacent lane or in the oncoming lane has been removed, when a dropped object that was present in the adjacent lane or in the oncoming lane has been removed or a disabled vehicle that was stopped in the adjacent lane or in the oncoming lane has been removed. That is, the removal-of-unavailability determination unit 5c may determine whether unavailability of autonomous driving has been removed not only for the lane of travel in which the own vehicle is traveling, but also for the adjacent lane or the oncoming lane.

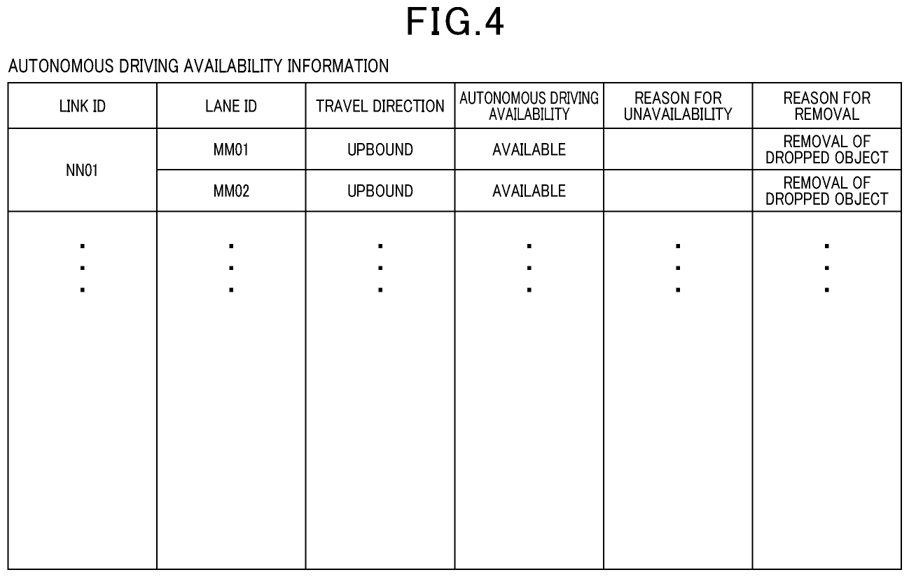

When the removal-of-unavailability determination unit 5c determines that unavailability of autonomous driving has been removed at the autonomous driving unavailable location, the reason-for-unavailability recording unit 5d records the reason for removal in association with the location where unavailability of autonomous driving has been removed. That is, as illustrated in FIG. 4, for example, when it is determined that unavailability of autonomous driving has been removed at the autonomous driving unavailable location, in response to removal of the dropped object that was present at the location specified by the link ID “NN01” and the lane IDs “MM01” and “MM02, the reason-for-unavailability recording unit 5b records “AVAILABLE” for the autonomous driving availability and “DROPPED OBJECT REMOVED” for the reason for removal.

When the reason-for-unavailability recording unit 5d records the reason for removal in association with the location where unavailability of autonomous driving has been removed, the transmission control unit 5e causes the data communication unit 6 to transmit the determination result and the reason for removal acquired from the removal-of-unavailability determination unit 5c to the server 3, as the removal notification information. The transmission control unit 5e causes the data communication unit 6 to transmit to the server 3 removal determination information that was used by the removal-of-unavailability determination unit 5c to determine that unavailability of autonomous driving has been removed at the autonomous driving unavailable location. That is, for example, in a case where removal of the dropped object is detected from the camera images and it is determined that unavailability of autonomous driving has been removed, the transmission control unit 5e causes the data communication unit 6 to transmit the camera images in which the dropped object is not captured, to the server 3 as the removal determination information.

The server 3 includes a control unit 9, a data communication unit 10, and a map database 11. The control unit 5 is configured as a microcomputer formed of a central processing unit (CPU), a read-only memory (ROM), a random-access memory (RAM), and an input/output (I/O) interface. The microcomputer executes one or more computer programs stored in a non-transitory tangible storage medium to perform processes corresponding to the computer programs, thereby controlling the overall operation of the server 3.

The data communication unit 10 controls data communication with the on-board devices 2 via the communication network 4. The map database 11 stores map data and may further store autonomous driving availability information in association with the map data. The autonomous driving availability information to be associated with the map data in the map database 11 is equivalent to the autonomous driving availability information to be associated with the map data in the map database 8 of each on-board device 2 described above. The map database 11 has a relatively large data storage capacity, and the map data stored in the map database 11 is map data covering a wide area according to locations of an unspecified number of vehicles. That is, the on-board device 2 downloads the map data around its own vehicle's location from the server 3 among the map data stored in the map database 11 of the server 3, and autonomous driving is enabled based on the downloaded map data.

The control unit 9 includes a notification information acquisition unit 9a, a notification information recording unit 9b, a determination information acquisition unit 9c, a determination information recording unit 9d, and a distribution control unit 9e. The notification information acquisition unit 9a acquires unavailability notification information and removal notification information by the data communication unit 10 receiving the unavailability notification information and the removal notification information transmitted from each on-board device 2. When the unavailability notification information or the removal notification information is acquired by the notification information acquisition unit 9a, the reason-for-unavailability recording unit 9b records the reason for unavailability or the reason for removal together with the determination result included in the acquired unavailability notification information or removal notification information, in association with the map database 11.

The determination information acquisition unit 9c acquires unavailability determination information and removal-of-unavailability determination information by the data communication unit 10 receiving the information transmitted from the on-board device 2. When the unavailability determination information or removal determination information is acquired by the determination information acquisition unit 9c, the determination information recording unit 9d records the acquired unavailability determination information or removal determination information in association with the map database 11.

The distribution control unit 9e causes the data communication unit 10 to distribute the map data stored in the map database 11 to an unspecified number of on-board devices or on-board devices that have requested map data. In this case, the map data stored in the map database 11 is associated with the autonomous driving availability information, such that the autonomous driving availability information is associated with the map data delivered from the server 3 to the on-board device 3. That is, the on-board devices 2 and the server 3 are in a many-to-one relationship in the autonomous driving availability determination system 1. Therefore, when the server 3 receives unavailability notification information or removal notification information regarding a location A transmitted from the on-board device 2 mounted to a vehicle A while the vehicle A is traveling in the location A, the server 3 records the received unavailability notification information or removal notification information. The server 3 may provide the unavailability notification information or removal notification information thus recorded to the on-board device 2 mounted to a vehicle B that is about to travel in the location A, thereby providing the unavailability notification information or removal notification information to the vehicle B.

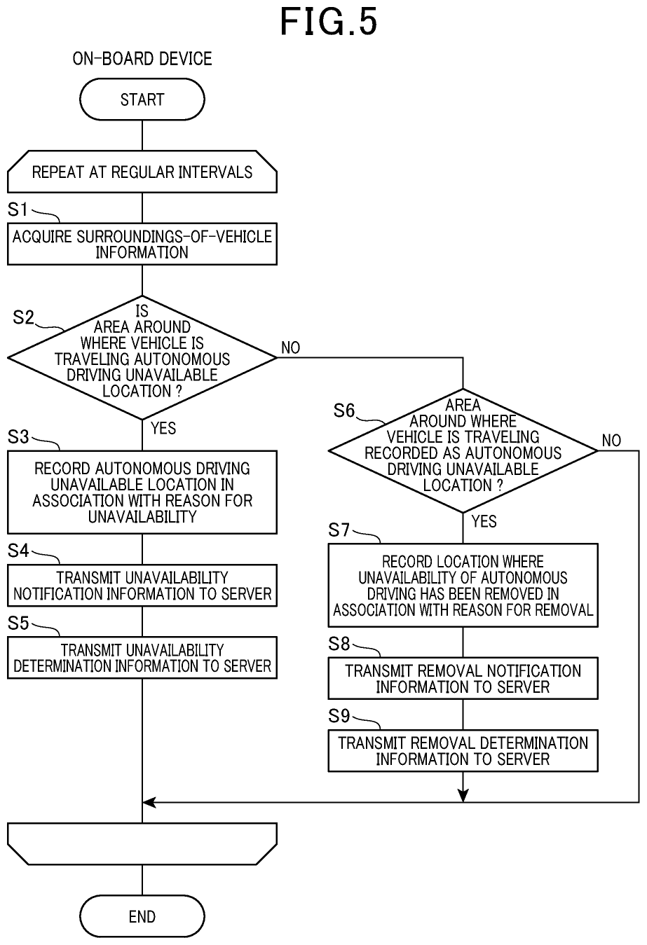

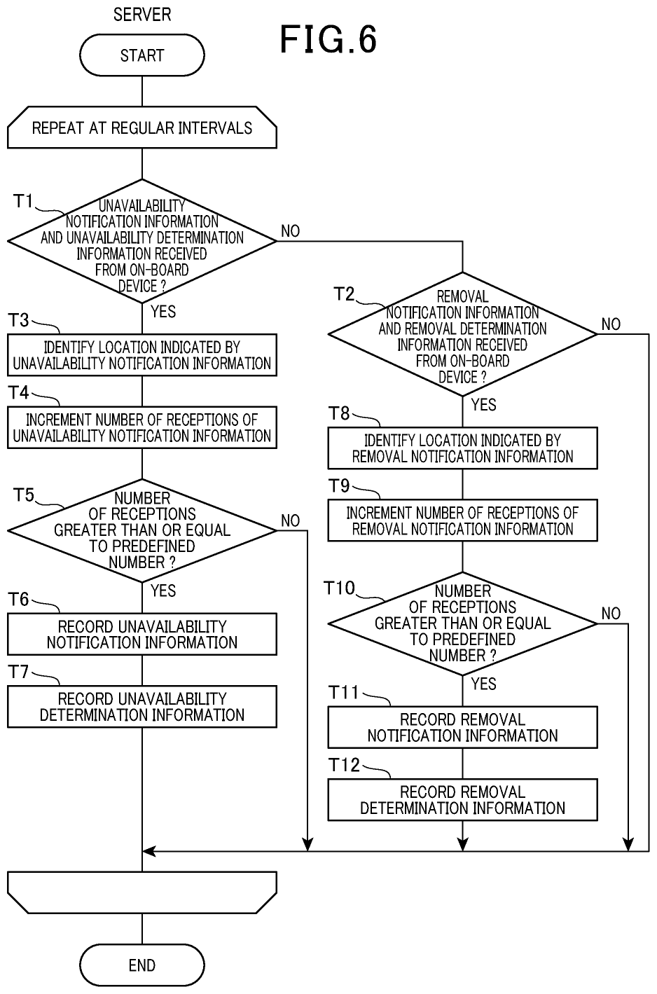

Functions of the above configuration will now be described with reference to FIGS. 5 to 6. Here, a process of determining unavailability of autonomous driving will be described as processing performed by the on-board device 2, and a process of receiving notification information and determination information to be transmitted from the on-board devices 2 will be described as processing performed by the server 3.

(1-1) Process of Determining Autonomous Driving Unavailable Location

In each on-board device 2, the control unit 5 repeatedly performs a process of determining an autonomous driving unavailable location at regular intervals. The control unit 5 acquires surroundings-of-vehicle information, such as camera images, sensor information, radar information and the like, via the probe information input unit 7 (at S1), and uses the acquired surroundings-of-vehicle information to determine whether the area around where the vehicle is traveling is an autonomous driving unavailable location (at S2, corresponding to determining an autonomous driving unavailable location). If determining that the area around where the vehicle is traveling is an autonomous driving unavailable location (“YES” branch of S2), the control unit 5 records the location as an autonomous driving unavailable location in association with a reason for unavailability (at S3). The control unit 5 causes the data communication unit 6 to transmit to the server 3 the determination result and the reason for unavailability as unavailability notification information (at S4, corresponding to controlling transmission). The control unit 5 causes the data communication unit 6 to transmit to the server 3 determination information that was used to determine that the area around where the vehicle is traveling is an autonomous driving unavailable location, as unavailability notification information (at S5). For example, in a case where the area around where the vehicle is traveling is determined to be an autonomous driving unavailable location from the camera images, the control unit 5 causes the data communication unit 6 to transmit to the server 3 the camera images as unavailability determination information.

If determining that the area around where the vehicle is traveling is not an autonomous driving unavailable location (“NO” branch of S2), the control unit 5 determines whether the area around where the vehicle is traveling has been recorded as an autonomous driving unavailable location (at S6). If determining that the area around where the vehicle is traveling is recorded as an autonomous driving unavailable location (“YES” branch of S6), the control unit records the location where unavailability of autonomous driving has been removed in association with a reason for removal (at S7). The control unit 5 causes the data communication unit 6 to transmit to the server 3 the determination result and the reason for removal as removal notification information (at S8). The control unit 5 causes the data communication unit 6 to transmit to the server 3 determination information that was used to determine that unavailability of autonomous driving has been removed, as removal determination information (at S9, corresponding to controlling transmission). For example, if determining that unavailability of autonomous driving has been removed using the camera images, the control unit 5 causes the data communication unit 6 to transmit to the server 3 the camera images as removal determination information.

(1-2) Process of Receiving Notification Information and Determination Information Transmitted from On-Board Devices 2

In the server 3, the control unit 9 repeatedly performs a process of receiving the notification information and the determination information transmitted from any of the on-board devices 2 at regular intervals. The control unit 9 determines reception of the notification information and the determination information transmitted from any of the on-board devices 2 (at T1 and T2). If determining that the unavailability notification information and the unavailability determination information transmitted from any of the on-board devices 2 have been received by the data communication unit 10 (“YES” branch of T1), the control unit 9 identifies the location indicated by the received unavailability notification information (at T3) and increments the number of receptions of the unavailability notification information per unit time for the identified location (T4). If determining that the resultant number of receptions is greater than or equal to a predefined number (“YES” branch of T5), the control unit 9 determines that the received unavailability notification information is credible, records the unavailability notification information, and records the reason for unavailability in association with the autonomous driving unavailable location (at T6).

The control unit 9 records the unavailability determination information and records the determination information that was used to determine that the identified location is an autonomous driving unavailable location (at T7). The control unit 9 can determine credibility of the unavailability notification information by verifying the unavailability notification information using the unavailability determination information. For example, in a case where the unavailability determination information is a camera image, the control unit 9 can determine credibility of the unavailability notification information by analyzing the camera image and determining that the image is of a dropped object. The verification of unavailability notification information by unavailability determination information may be performed automatically by the server 3 using a predefined verification algorithm, or may be performed manually by operator's visual inspection.

Such verification of the unavailability notification information using the unavailability determination information reduces the possibility of erroneously registering in the map database 11 a location where it is possible to continue autonomous driving as an autonomous driving unavailable location. For example, if a driver cancels autonomous driving due to an occupant's mood, such as a sudden desire to stop at a service area, the location may not be registered in the map database 11 as an unavailability of autonomous driving unavailable location, thereby avoiding a situation in which the location is erroneously registered in the map database 11 as an autonomous driving unavailable location. Verifying the unavailability notification information using the unavailability determination information in this way, rather than just using the unavailability notification information transmitted from any of the on-board devices 2, can increase the reliability and accuracy of the unavailability notification information. The same applies to the case of verifying the removal notification information using the removal determination information described later. Verifying the removal notification information using the removal determination information can increase the reliability and certainty of the removal notification information.

If determining that the removal notification information and the removal determination information transmitted from any of the on-board devices 2 have been received by the data communication unit 10 (“YES” branch of T2), the control unit 9 identifies the location indicated by the received removal notification information (at T8) and increments the number of receptions of the removal notification information per unit of time for the identified location (at T9). If determining that the resultant number of receptions is greater than a predefined number (“YES” branch of T10), the control unit 9 determines that the received removal determination information is credible, records the removal notification information, and records the reason for removal in association with the location where unavailability of autonomous driving has been removed (at T11).

The control unit 9 records the removal determination information and records the determination information that was used to determine that unavailability of autonomous driving has been removed (at T2). The control unit 9 can determine the credibility of the removal notification information by verifying the removal notification information using the removal determination information. For example, if the removal determination information is a camera image, the control unit 9 can determine the credibility of the removal notification information by analyzing the camera image and determining that the image does not capture a dropped object. Verification of the removal notification information using the removal determination information may be performed automatically by the server 3 using a predefined verification algorithm, or may be performed manually, for example, by operator's visual inspection.

Upon recording the unavailability notification information and the removal notification information in this way, the server 3 distributes the recorded unavailability notification information and removal notification information to an unspecified number of on-board devices. That is, the server 3 collects unavailability notification information and removal notification information from an unspecified number of on-board devices 2, and provides the collected unavailability notification information and removal notification information to an unspecified number of on-board devices 2. Upon receiving the unavailability notification information and the removal notification information distributed from the server 3, each on-board device 2 updates the map data stored in the map database 8 according to the received unavailability notification information and removal notification information, and controls autonomous driving. For example, in a case where there is an autonomous driving unavailable location on a route during automatic driving, the on-board device 2 switches from automatic driving to manual driving, or in a case where there is a location on a route during manual driving where unavailability of autonomous driving has been removed, the on-board device 2 switches from manual driving to automatic driving.

The server 3 may limit the distribution of unavailability notification information not to an unspecified number of on-board devices 2, but to on-board devices 2 that are expected to pass through an autonomous driving unavailable location. The on-board devices 2 that are expected to pass through an autonomous driving unavailable location are on-board devices 2 that are traveling toward an autonomous driving unavailable location on a road where the autonomous driving unavailable location has been set, on-board devices 2 for which a scheduled travel route that includes an autonomous driving unavailable location has been set, and so on. The server 3 may limit the distribution of removal notification information not to an unspecified number of on-board devices, but to on-board devices that have already received the unavailability notification information for the location indicated by the removal notification information. Thus limiting on-board devices to which the unavailability notification information and the removal notification information are to be distributed can suppress communication loads and communication volumes of on-board devices 2 and the server 3.

The first embodiment as described above can provide the following advantages.

Each on-board device 2 is configured to determine whether the area around where the own vehicle is traveling is an autonomous driving unavailable location, and transmit the determination result to the server 3. The on-board device 2 is configured to, in response to determining that the area around where the own vehicle is traveling is not an autonomous driving unavailable location, transmit such information to the server 3, thereby causing the server 3 to appropriately reflect the fact that unavailability of autonomous driving has been removed. The server 3 is enabled to distribute the fact that unavailability of autonomous driving has been removed to an unspecified number of on-board devices 2 or specific on-board devices 2.

The on-board device 2 is configured to, in response to determining that the area around where the vehicle is traveling is an autonomous driving unavailable location, record the location as an autonomous driving unavailable location in association with a reason for unavailability. This allows the reason for unavailability regarding why the area around where the vehicle is traveling is determined to be an autonomous driving unavailable location to be recorded in the own vehicle. The on-board device 2 is configured to transmit to the server 3 the reason for unavailability regarding why the area around where the vehicle is traveling is determined to be an autonomous driving unavailable location, as unavailability notification information. This can cause the server 3 to reflect the reason for unavailability regarding why the area around where the vehicle is traveling is determined to be an autonomous driving unavailable location. The server 3 is enabled to distribute the reason for unavailability regarding why the area around where the vehicle is traveling is determined to be an autonomous driving unavailable location to an unspecified number of on-board devices 2 or specific on-board devices 2.

The on-board device 2 is configured to transmit to the server 3 determination information that was used to determine that the area around where the vehicle is traveling is an autonomous driving unavailable location, as unavailability determination information. For example, the server 3 may therefore be enabled to reflect camera images, sensor information, radar information or the like, that was used to determine that the area around where the vehicle is traveling is an autonomous driving unavailable location, and verify the camera images, the sensor information, or the radar information or the like, and determine credibility of the result of determination by the on-board device 2 that the area around where the own vehicle is traveling is an autonomous driving unavailable location.

The on-board device 2 is configured to, in response to determining that unavailability of autonomous driving has been removed at the autonomous driving unavailable location, record the autonomous driving unavailable location as a location where unavailability of autonomous driving has been removed, in association with the reason for removal. The reason for removal of unavailability of autonomous driving may be recorded in the own vehicle. The on-board device 2 is configured to transmit to the server 3 the reason for removal regarding why unavailability of autonomous driving has been removed at the autonomous driving unavailable location, as removal notification information. This can cause the server 3 to reflect the reason for removal regarding why unavailability of autonomous driving is determined to have been removed. The server 3 is enabled to distribute the reason for removal regarding why unavailability of autonomous driving is determined to have been removed to an unspecified number of on-board devices 2 or specific on-board devices 2.

The on-board device 2 is configured to transmit to the server 3 determination information that was used to determine that unavailability of autonomous driving has been removed at the autonomous driving unavailable location, as removal determination information. For example, the server 3 may be configured to reflect camera images, sensor information, radar information or the like, that was used to determine that unavailability of autonomous driving has been removed, and verify the camera images, the sensor information, the radar information or the like, and determine credibility of the result of determination by the on-board device 2 that unavailability of autonomous driving has been removed at the autonomous driving unavailable location.

### Second Embodiment

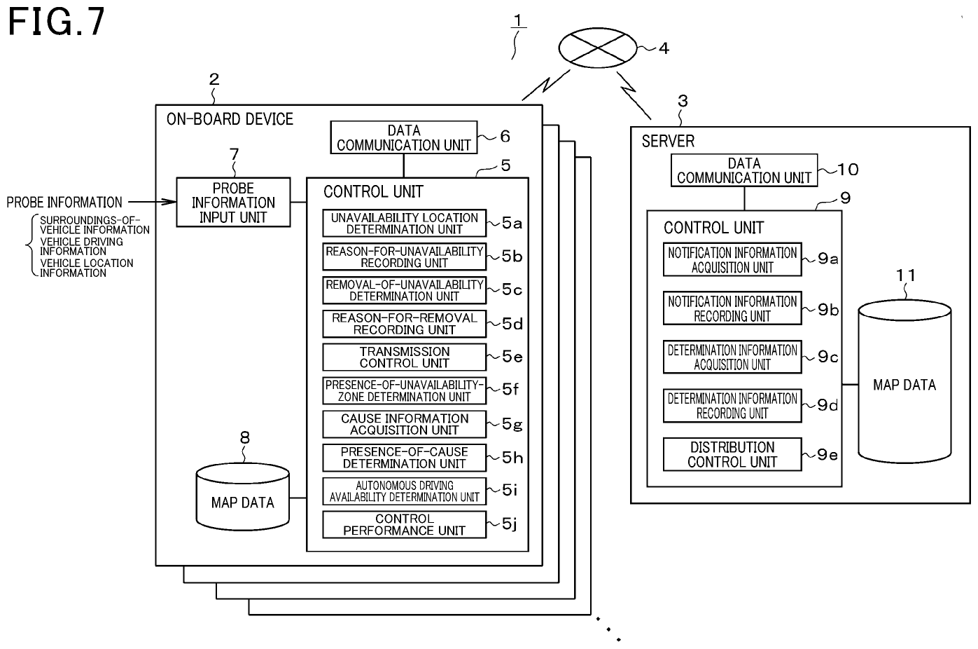

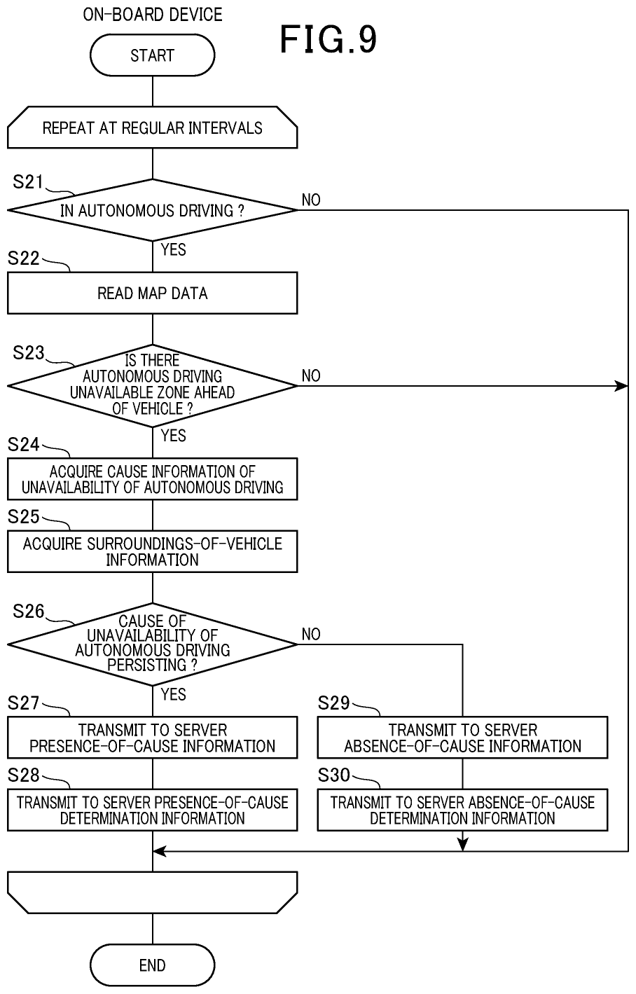

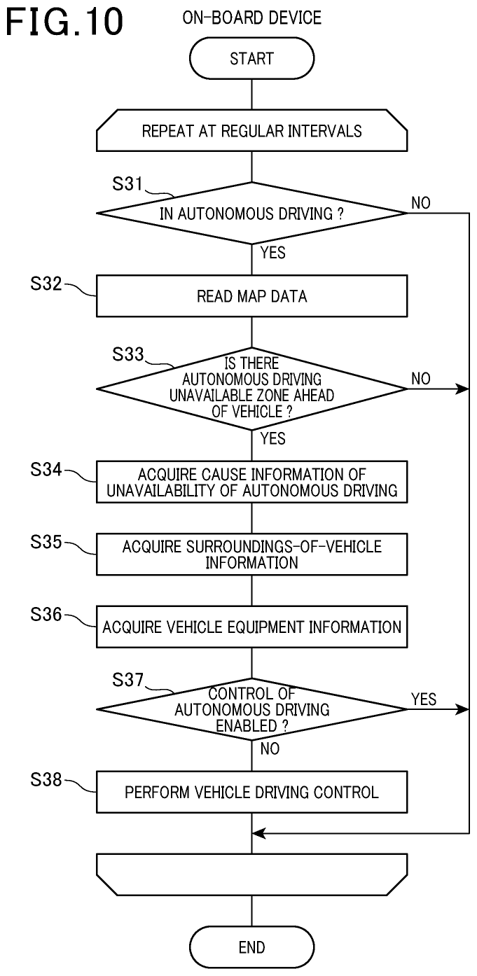

A second embodiment will now be described with reference to FIGS. 7 to 10. In the first embodiment, it is sequentially determined whether the area around where the own vehicle is traveling is an autonomous driving unavailable location, based on surroundings-of-vehicle information, such as camera images, sensor information, and radar information. In a second embodiment, it is determined whether there is an autonomous driving unavailable zone ahead of the own vehicle based on forward information related to a travel route included in map data stored in the map database 8. In a case where there is an autonomous driving unavailable zone ahead of the own vehicle, it is determined whether autonomous driving control is enabled.

In each on-board device 2, as illustrated in FIG. 7, in addition to the unavailability location determination unit 5a, the reason-for-unavailability recording unit 5b, the removal-of-unavailability determination unit 5c, the reason-for-removal recording unit 5d, and the transmission control unit 5e as described in the first embodiment, the control unit 5 further includes a presence-of-unavailability-segment determination unit 5f, a cause information acquisition unit 5g, a presence-of-cause determination unit 5h, an autonomous driving availability determination unit 5i, and a control performance unit 5j.

The presence-of-unavailability-segment determination unit 5f determines whether there is an autonomous driving unavailable zone ahead of the own vehicle using forward information of a travel route included in map data stored in the map database 8. In a case where the presence-of-unavailability-segment determination unit 5f determines that there is an autonomous driving unavailable zone ahead of the own vehicle, the cause information acquisition unit 5g acquires cause information of unavailability of autonomous driving included in the map data stored in the map database 8. For example, in a case where the presence-of-unavailability-segment determination unit 5g determines that there is an autonomous driving unavailable zone ahead of the own vehicle due to the presence of a dropped object or stopping of a disabled vehicle as forward information of the travel route, the cause information acquisition unit 5g acquires, as cause information of unavailability of autonomous driving, the presence of the dropped object or stopping of the disabled vehicle.

The presence-of-cause determination unit 5h uses surroundings-of-vehicle information to determine whether a cause of unavailability of autonomous driving indicated by the cause information of unavailability of autonomous driving acquired by the cause information acquisition unit 5g persists. In a case where the probe information input unit 7 has received surroundings-of-vehicle information, such as camera images, sensor information, radar information or the like, the presence-of-cause determination unit 5h uses the received surroundings-of-vehicle information to determine whether the presence of the dropped object or the stopping of the disabled vehicle is continuing. In a case where the presence of the dropped object or the stopping of the disabled vehicle is continuing, the presence-of-cause determination unit 5h determines that the cause of unavailability of autonomous driving persists. In a case where neither the presence of the dropped object nor the stopping of the disabled vehicle is continuing, the presence-of-cause determination unit 5h determines that the cause of unavailability of autonomous driving does not persist.

In a case where the presence-of-unavailability-segment determination unit 5f determines that there is an autonomous driving unavailable zone ahead of the own vehicle, the autonomous driving availability determination unit 5i determines whether autonomous driving is available based on the cause information of unavailability of autonomous driving acquired by the cause information acquisition unit 5g and vehicle equipment of the own vehicle. For example, in a case where the cause of unavailability of autonomous driving is the presence of a dropped object, the autonomous driving availability determination unit 5i calculates a relative relationship between the position or size of the dropped object, a lane width of the lane of travel, a width of the own vehicle and the like, and determines whether autonomous driving is available. For example, in a case where the position of the dropped object is off the virtual center line of the lane of travel or its size is relatively small, the autonomous driving availability determination unit 5i determines that autonomous driving is available. In a case where the position of the dropped object is on the virtual center line of the lane of travel or its size is relatively large, the autonomous driving availability determination unit 5i determines that autonomous driving is unavailable

For example, in a case where the cause of unavailability of autonomous driving is poor image recognition performance due to sunlight backlighting, the autonomous driving availability determination unit 5i calculates a relative relationship between the position of the sun, the performance of the on-board camera and the like, to determine whether autonomous driving is unavailable. In a case where the performance of the on-board camera is high, for example, due to a relatively wide dynamic range, the autonomous driving availability determination unit 5i determines that autonomous driving is available, while in a case where the performance of the on-board camera is relatively low, for example, due to a relatively narrow dynamic range, the autonomous driving availability determination unit determines that autonomous driving is unavailable. In a case where the autonomous driving availability determination unit 5i determines that autonomous driving is unavailable, the control performance unit 5j performs vehicle driving control.

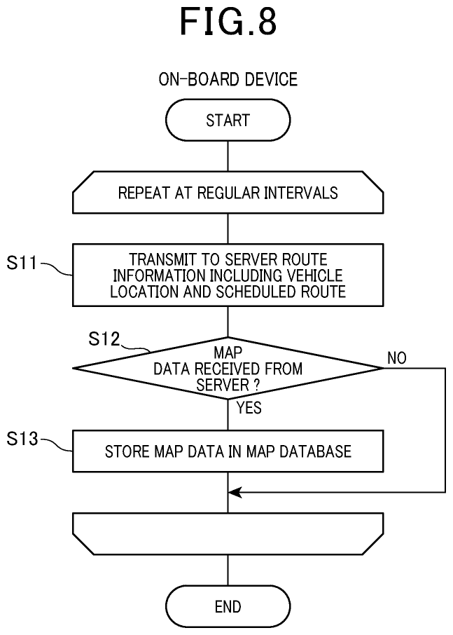

Functions of the above configuration will now be described with reference to FIGS. 8 to 10. A process of downloading map data from the server 3, a process of acquiring cause information, and a process of performing autonomous driving will now be described as processes performed by each on-board device 2.

(2-1) Process of Downloading Map Data from Server 3

In each on-board device 2, the control unit 5 repeatedly performs the process of downloading map data from the server at regular intervals. The control unit 5 causes the data communication unit 6 to transmit to the server 3 route information including a location and a scheduled travel route of the own vehicle (at S11). Upon receiving the route information transmitted from the on-board device 2, the server 3 distributes to the on-board device 2 the map data corresponding to the location and the scheduled travel route of the own vehicle identified by the received route information. If the data communication unit 6 receives the map data distributed from the server 3 (“YES” branch of S12), the control unit 5 stores the received map data in the map database 8 (at S13).

(2-2) Process of Acquiring Cause Information

In each on-board device 2, the control unit 5 repeatedly performs the process of acquiring cause information at regular intervals. The control unit 5 determines whether the own vehicle is in automatic driving (at S21). If determining that the own vehicle is in automatic driving (“YES” branch of S21), the control unit 5 reads map data stored in the map database 8 (at S22) and determines whether there is an autonomous driving unavailable zone ahead of the own vehicle, using forward information of a travel route included in the read map data. If determining that there is an autonomous driving unavailable zone ahead of the own vehicle (“YES” branch of S23), the control unit 5 acquires cause information of unavailability of autonomous driving included in the map data (at S24). The control unit 5 acquires surroundings-of-vehicle information (at S25) and determines whether the cause of unavailability of autonomous driving indicated by the acquired cause information of unavailability of autonomous driving persists, based on the surroundings-of-vehicle information (at S26).

That is, if determining that there is an autonomous driving unavailable zone ahead of the own vehicle due to, for example, the presence of a dropped object, and determining that a dropped object is detected based on a result of analysis of the camera image, the control unit 5 determines that the cause of unavailability of autonomous driving indicated by the cause information of unavailability of autonomous driving persists. If determining that the cause of unavailability of autonomous driving persists (“YES” branch of S26), the control unit 5 causes the data communication unit 6 to transmit to the server 3 presence-of-cause information indicating that the cause of unavailability of autonomous driving persists (at S27), and causes the data communication unit 6 to transmit to the server 3 presence-of-cause determination information that was used to determine that the cause of unavailability of autonomous driving persists (at S28).

For example, if determining that the cause of unavailability of autonomous driving persists due to the presence of a dropped object, the control unit 5 causes the data communication unit 6 to transmit to the server 3 the camera image or the like in which the dropped object is captured, as the presence-of-cause determination information. Reception of the presence-of-cause information transmitted from the on-board device 2 allows the server 3 to determine that the autonomous driving unavailable zone registered in the map data persists. Reception of the presence-of-cause determination information transmitted from the on-board device 2 allows the server 3 to determine the cause of persistence of the autonomous driving unavailable zone.

However, if determining that an autonomous driving unavailable zone persists ahead of the own vehicle, for example, due to the presence of a dropped object, but not having detected a dropped object based on the result of analysis of the camera image, the control unit 5 determines that the cause of unavailability of autonomous driving indicated by the cause information of unavailability of autonomous driving does not persist. If determining that the cause of unavailability of autonomous driving does not persist (“NO” branch of S26), the control unit 5 causes the data communication unit 6 to transmit to the server 3 absence-of-cause information indicating that the cause of unavailability of autonomous driving does not persist (S29), and causes the data communication unit 6 to transmit to the server 3 absence-of-cause determination information that was used to determine that the cause of unavailability of autonomous driving does not persist (S30).

If determining that the cause of unavailability of autonomous driving does not persist because, for example, the dropped object has been removed, the control unit 5 causes the data communication unit 6 to transmit to the server 3 the camera image in which no dropped object is captured, as absence-of-cause determination information. Reception of the absence-of-cause information transmitted from the on-board device 2 allows the server 3 to determine that the autonomous driving unavailable zone registered in the map data no longer persists and has been eliminated. Reception of the absence-of-cause determination information transmitted from the on-board device 2 allows the server 3 to determine cause of elimination of the autonomous driving unavailable zone.

(2-3) Process of Performing Autonomous Driving

In each on-board device 2, the control unit 5 repeatedly performs the process of performing autonomous driving at regular intervals. The control unit 5 determines whether the own vehicle is in autonomous driving (at S31). If determining that the own vehicle is in autonomous driving (“YES” branch of S31), the control unit 5 reads map data stored in the map database 8 (at S32) and determines whether there is autonomous driving unavailable zone ahead of the own vehicle using the forward information of the travel route included in the read map data (at S33). If determining that there is autonomous driving unavailable zone ahead of the own vehicle (“YES” branch of S33), the control unit 5 acquires the cause information of unavailability of autonomous driving included in the map data (at S34). The control unit 5 acquires surroundings-of-vehicle information (at S35) and vehicle equipment information (at S36), and determines whether autonomous driving is available based on the acquired cause information of unavailability of autonomous driving, the surroundings-of-vehicle information, and the vehicle equipment information (at S37).

For example, in a situation where sunlight exposure may affect the imaging brightness of the camera, the control unit 5 determines that autonomous driving is available if the own vehicle is equipped with a high-performance camera as vehicle equipment, while the control unit 5 determines that autonomous driving is unavailable if the own vehicle is not equipped with any high-performance camera as vehicle equipment. For example, in a case where there is a dropped object, the control unit 5 calculates a relative relationship between a size of the dropped object, a road width, a vehicle width and the like, and determines that autonomous driving is available if the vehicle can avoid the dropped object and pass through avoiding it, while the control unit 5 determines that autonomous driving is unavailable if the vehicle cannot avoid the dropped object and pass through avoiding it.

If determining that autonomous driving is unavailable (“NO” branch of S37), the control unit controls vehicle driving based on the cause information of unavailability of autonomous driving, the surroundings-of-vehicle information, and the vehicle equipment information (at S38). That is, for example, if autonomous driving is unavailable in the lane of travel, but is available in an adjacent lane, the control unit 5 may make a lane change from the lane of travel to the adjacent lane. For example, if autonomous driving is unavailable in the lane of travel and there is no adjacent lane, the control unit 5 may change the travel route or switch from automatic driving to manual driving. The control unit 5 may decelerate the own vehicle, for example, if the own vehicle at the end of a traffic jam or if the road surface is icy.

The second embodiment as described above can provide the following advantages.

Each on-board device 2 is configured to, in response to determining that there is an autonomous driving unavailable zone ahead of the own vehicle using forward information of a travel route included in map data, acquire cause information of unavailability of autonomous driving, determine whether the cause of unavailability of autonomous driving indicated by the cause information of unavailability of autonomous driving persists, and transmit a result of determination to the server 3. Determining whether the cause of unavailability of autonomous driving indicated by the cause information of unavailability of autonomous driving persists and then transmitting such information to the server allows the server to appropriately reflect whether the cause of unavailability of autonomous driving persists. The server is enabled to distribute a determination as to whether the cause of unavailability of autonomous driving persists to an unspecified number of on-board devices.

The on-board device 2 is configured to transmit to the server 3 determination information that was used to determine that the cause of unavailability of autonomous driving indicated by the cause information of unavailability of autonomous driving persists, as presence-of-cause determination information. The server 3 is configured to reflect, for example, camera images, sensor information, radar information or the like, that was used to determine that the cause of unavailability of autonomous driving persists, and verify the camera images, the sensor information, the radar information or the like, and determine credibility of the result of determination that the cause of unavailability of autonomous driving persists.

The on-board device 2 is configured to, in response to determining that there is an autonomous driving unavailable zone ahead of the own vehicle, determine whether autonomous driving is available, based on the cause information of unavailability of autonomous driving and its own vehicle equipment. Matching the cause information of unavailability of autonomous driving with the own vehicle equipment makes it possible to determine whether autonomous driving is available.

The on-board device 2 is configured to, in response to determining that autonomous driving is unavailable, perform vehicle driving control. Performing vehicle driving control when autonomous driving is unavailable enables appropriate handling.

### Other Embodiments

While the disclosure has been described in accordance with the embodiments, it is understood that the disclosure is not limited to such embodiments or structures. The disclosure also encompasses various modifications and variations within the scope of equivalence. Furthermore, various combinations and modes, as well as other combinations and modes including only one element, more or less, thereof, are also within the scope and idea of the disclosure.

As vehicle driving control in a case where it is determined that autonomous driving is unavailable, in a situation where the lane in which the own vehicle is traveling is autonomous driving available, but its adjacent lane is autonomous driving unavailable, interruption from the adjacent lane into the lane of travel of the own vehicle is anticipated, and the driver may be alerted to be on the lookout for such interruption.

In a case where autonomous driving is unavailable due to bad weather, acquiring weather information from an external server enables estimation of the time when the weather will recover and the reason for unavailability will be eliminated, or route guidance in areas where the weather has recovered. In a case where autonomous driving is unavailable due to road surface freezing or snow on the road surface, the driving mode may be switched from autonomous driving to manual driving and an alert may be provided to the driver of the speed limit.

The server 3 may be configured to, in a case where the cause of unavailability of autonomous driving is a dropped object, record characteristic information indicating the color, size, and other characteristics of the dropped object in order to facilitate determining whether the dropped object detected by the on-board device 2 has been removed, that is, whether the own vehicle has returned to a state where autonomous driving is available. For example, the on-board device 2 may be configured to, in response to determining that the cause of unavailability of autonomous driving is a dropped object, transmit to server 3 unavailability notification information including characteristic information of the dropped object. The server 3 may then be configured to, in a case where the cause of unavailability of autonomous driving is a dropped object and the feature information transmitted from the on-board device 2 has been received, record that the cause of unavailability of autonomous driving is a dropped object and further record the characteristic information in association with the dropped object. The on-board device 2 may be configured to transmit to the server 3 cause-captured images that are images of the dropped object, as the characteristic information. In this case, the server 3 can store the cause-captured images transmitted from the on-board device 2 and distribute the map data including the cause-captured images to on-board devices 2 that are scheduled to pass through the location where the dropped object exists. The on-board device 2 may be configured to determine whether the cause of unavailability of autonomous driving has been eliminated, based on the cause-captured images delivered from the server 3. The server 3 may further be configured to extract characteristic information by analyzing the images of the dropped object transmitted from the on-board device 2.

The length of a congested segment may increase or decrease over time. That is, the length of a congested segment may expand or contract. Where autonomous driving is unavailable due to the traffic jam, the server 3 may be configured to determine the presence or absence of a traffic jam or determine the end of a traffic jam by accessing external information, such as Vehicle Information and Communication System (VICS) (registered trademark), as necessary, and update an area where autonomous driving is unavailable, as appropriate. The on-board device 2 transmitting location information to the server 3 regarding the location of the traffic jam allows the server 3 to identify a congested area based on the location information transmitted from the on-board device 2. This can increase the freshness of traffic jam information as compared to information from the VICS or the like.

The server 3 may be configured to predict changes in road surface temperature based on weather information, and set or cancel autonomous driving unavailable locations caused by road surface freezing or snow on the road surface. That is, the server 3 may be configured to, for example, predict the location and time when autonomous driving becomes difficult due to road surface freezing or snow on the road surface from, for example, a result of prediction of changes in road surface temperature, and set the locations where autonomous driving is unavailable. The server 3 may be configured to, for a zone set to be autonomous driving unavailable due to road surface freezing or snow on the road surface, predict the time of return to a state where autonomous driving is available based on the weather information and predicted changes in road surface temperature, and update the autonomous driving availability information. The on-board device 2 or the server 3 may be configured to determine that a zone with road surface freezing is unavailable for autonomous driving, and for such a zone set to be autonomous driving unavailable due to road surface freezing, determine the zone has returned to a state where autonomous driving is available, based on the fact that the road surface is no longer icy. The on-board device 2 or the server 3 may be determine a location where the amount of snow accumulation exceeds a predefined threshold as an autonomous driving unavailable zone where snow accumulation on the road surface has occurred, and for such a zone set to be autonomous driving unavailable due to snow accumulation on the road surface, determine that the zone has returned to a state where autonomous driving is available, based on the amount of snow accumulation decreasing to below the predefined threshold and the snow accumulation on the road surface has been cleared.

There may be a configuration in which a road condition for autonomous driving stipulates that the number of lanes is greater than or equal to a predefined number n. The predefined number n is an integer greater than or equal to “2,” for example, “2,” “3,” “4,” and so on. In such a configuration, the server 3 may be configured to set a zone where the number of valid lanes is less than n due to obstacles on the road, such as dropped objects, construction zones, or vehicles parked on the road, as an autonomous driving unavailable zone. The number of valid lanes is the number of lanes in which vehicles can actually travel. For example, in a case where one lane of a two-lane road is blocked by an obstacle, the number of valid lanes on the road is “1”. The server 3 may be configured to, in a case where the cause of unavailability of autonomous driving is an insufficient number of valid lanes due to obstacles on the road, cancel the setting of unavailability of autonomous driving in response to confirming disappearance of the obstacles on the road. The criterion for autonomous driving availability used by the on-board devices 2 may be the same as that of the server 3.

There may be a configuration in which an environmental condition for autonomous driving stipulates that there are no pedestrians within a predefined distance from the location of the own vehicle in the direction of travel on a limited highway. In such a configuration, the server 3 may be configured to set a location where a pedestrian is entering a limited highway as an autonomous driving unavailable location. The server 3 may be configured to, in a case where the cause of unavailability of autonomous driving is such a pedestrian entering the limited highway, cancel the setting of unavailability of autonomous driving in response to confirming that the pedestrian has left the limited highway. The criterion for determining autonomous driving availability used by the on-board device 2 may be the same as that of the server 3. The limited highways include toll roads, such as expressways.

There may be a configuration in which the environmental condition for autonomous driving stipulates weather conditions. In such a configuration, the server 3 may be configured to set a location where the amount of rainfall exceeds a predefined threshold as an autonomous driving unavailable location. The server 3 may be configured to, in a case where the cause of unavailability of autonomous driving is such rainfall, cancel the setting of unavailability of autonomous driving in response to confirming that the amount of rainfall is below the predefined threshold. The criterion for autonomous driving availability used by the on-board devices 2 may be the same as that of the server 3. The threshold related to the amount of rainfall for canceling the setting of unavailability of autonomous driving may be set to a smaller value than the threshold related to the amount of rainfall for setting the autonomous driving unavailable location, and such a configuration can guarantee greater safety. The server 3 may be configured to, in a case where the cause of unavailability of autonomous driving is rainfall, cancel the setting of unavailability of autonomous driving in response to confirming that the amount of rainfall is below the predefined threshold and the road surface condition has recovered to a predefined state. The condition of the road surface that allows autonomous driving may be defined, for example, as a condition where the road is not flooded or covered with snow.

There may be a configuration in which a condition for autonomous driving stipulates that GPS positioning with a predefined accuracy is available. In such a configuration, the server 3 may be configured to set a location where the GPS positioning error exceeds a predefined tolerance range or the GPS positioning is unavailable in the first place, as autonomous driving unavailable location. The server 3 may be configured to, in a case where the cause of unavailability of autonomous driving is the positioning status of GPS, cancel the setting of unavailability of autonomous driving in response to confirming that the GPS positioning accuracy is at an acceptable level. The criterion for autonomous driving availability by the on-board devices 2 may be the same as that of the server 3.

There may be a configuration in which the condition for autonomous driving stipulates that autonomous driving available locations are locations where the on-board devices 2 and the server are communicable by a fourth or fifth generation mobile communication system (so-called 4G or 5G). In such a configuration, the server 3 may be configured to set a location where communication connection to wireless base stations in the wireless communication system is not available due to deterioration of the radio wave condition, as an autonomous driving unavailable location. The server 3 may be configured to, in a case where the cause of unavailability of autonomous driving is the connection status of wireless communication, cancel the setting of unavailability of autonomous driving in response to confirming that the radio wave condition has become favorable. The criterion for autonomous driving availability by the on-board devices 2 may be the same as that of the server 3.

The present disclosure is not limited to the configuration where the process of determining whether the area around where the own vehicle is traveling is an autonomous driving unavailable location at step S2 described with reference to FIG. 5 and the process of determining whether the cause of unavailability of autonomous driving persists at step S26 are performed by the on-board device 2 mounted to a vehicle provided with the autonomous driving function. Alternatively, these processes may be performed by the on-board device 2 mounted to a vehicle not provided with any autonomous driving function, but provided with a surroundings monitoring sensor, such as a camera. Autonomous driving in the present disclosure may include driving assistance levels (so-called autonomous driving levels 1-2) in which the system supports at least one of steering operation and acceleration/deceleration operation. Autonomous driving may correspond to Levels 3 to 5 as defined by the “Society of Automotive Engineers (SAE) International”. The SAE International is a non-profit organization in the U.S. whose members are mobility professionals. Level 3 refers to a level where the system performs all driving operations in the ODD, but in an emergency, the system transfers control authority to the driver. Level 4 refers to a level where the system performs all driving operations in the ODD. Level 5 refers to a level where the system performs all driving operations without locational limitations.

The determinants for autonomous driving availability may be received from an on-board communication device mounted to a preceding vehicle ahead of the own vehicle via vehicle-to-vehicle communication or from a roadside communication device mounted to a roadside device via roadside-to-vehicle communication. For example, in a case where the preceding vehicle is a large vehicle, such as a truck or trailer, and the forward visibility from the own vehicle is not good, the determinants for autonomous driving availability may be received from an on-board communication device mounted to the preceding vehicle via vehicle-to-vehicle communication.

Each on-board device 2 may be configured to perform vehicle control based on information delivered from the server 3 without verifying the information delivered from server 3. The on-board device 2 may be configured to uniformly verify the information delivered from server 3, or may be configured to switch between autonomous driving or manual driving according to user operations or driving scenes.

The server 3 may be configured to update information about autonomous driving locations after statistically processing not only the information transmitted from one on-board device 2, but also the information transmitted from a plurality of on-board devices 2. Statistical processing includes averaging and majority voting. The server 3 may be configured to distribute the autonomous driving unavailable location and the cause of unavailability of autonomous driving with a degree of confidence assigned. The degree of confidence may be evaluated based on, for example, the number of pieces of data used in the statistical processing, or the variation (e.g., variance and standard deviation) in determination results of the respective on-board devices 2. The greater the number of pieces of data used in the statistical processing and the smaller the variation in determination results of the respective on-board devices 2, the higher the degree of confidence can be evaluated. In order to increase the freshness of information about autonomous driving unavailable locations, the server 3 may be configured to determine setting or cancelation of the autonomous driving unavailable locations based on the information transmitted from the on-board devices 2 within the most recent predefined time period. The predefined time period is preferably in units of several tens of minutes, but may be an hour or a day. When statistically processes the information transmitted from the plurality of on-board devices 2, the server 3 may be configured to, in response to successively confirming that the cause of unavailability of autonomous driving has been removed based on image analysis, immediately cancel setting of the autonomous driving unavailable location without waiting for accumulation of information transmitted from the plurality of on-board devices 2. According to such a configuration, the real-time nature of the information delivered from the server 3 to the on-board devices 2 can be improved.

The number of times the server 3 receives notification information transmitted from the on-board devices 2 used to update setting or cancellation of an autonomous driving unavailable location, in other words, the number of updates required to update setting or cancellation of an autonomous driving unavailable location, may be variably set according to characteristics of the cause of unavailability of autonomous driving. The required number of updates corresponds, for example, to the predefined number of times described in steps T5 and T10 of FIG. 6. The server 3 may be configured to, in a case where the cause of unavailability of autonomous driving is a quasi-static factor, such as road construction, set the required number of updates to a relatively high value, such as 20, 30 or the like. The server 3 may be configured to, in a case where the cause of unavailability of autonomous driving is a quasi-dynamic factor, such as a guerrilla downpour, set the required number of updates to a relatively low value, such as 5, 10 or the like. The quasi-static factors are temporary environmental factors that are expected to last from a few hours to a few days, such as construction, lane restrictions, snow accumulation, and the like. The quasi-dynamic factors are environmental factors that are expected to have a shorter duration than the quasi-static factors, such as dropped objects, vehicles parked on public roads, pedestrians entering a limited highway and the like. The server 3 may be configured to, in a case where the cause of unavailability of autonomous driving is a quasi-static factor, set the required number of updates to be smaller than in a case where the cause of unavailability of autonomous driving is a quasi-static actor. The smaller the required number of updates, the more frequently the settings can be updated, which makes it easier to ensure the real-time setting or cancellation of the autonomous driving unavailable location by the quasi-dynamic factor. In a case where the cause of unavailability of autonomous driving is a quasi-static factor, the determination is to be made based on notification information and determination information transmitted from a relatively large number of on-board devices 2, which increases reliability when updating the setting or cancellation of autonomous driving unavailable locations.

The on-board device 2 may be configured to perform the process of determining whether a traveling location that is a location where the own vehicle is passing over, or a location a predefined distance ahead from the traveling location is available for autonomous driving constantly, or only when passing over a location that has been determined to be autonomous driving unavailable.

As described above, each on-board device 2 is configured to determine the presence or absence of a cause of unavailability of autonomous driving and transmit the determination result to the server 3. The server 3 is configured to statistically process the determination result transmitted from each on-board device 2 to thereby set or cancel the autonomous driving unavailable location. The present disclosure is not limited to such a configuration. Alternatively, the server 3 may be configured to collect determinants, such as surroundings-of-vehicle information, vehicle driving information, and vehicle location information, from each on-board device 2, and make a direct determination based on the collected determinants. That is, the on-board device 2 does not necessarily have to be provided with a function to determine autonomous driving availability. The server 3 may be configured to use images taken by cameras installed in infrastructure facilities, such as roadside devices, to determine the presence or absence of a cause of unavailability of autonomous driving.

The controller and its method described in relation to the present disclosure may be implemented by a dedicated computer that is provided by forming a processor and a memory programmed to execute one or more functions embodied by a computer program. Otherwise, the controller and its method described in relation to the present disclosure may be implemented by a dedicated computer that is provided by forming a processor from one or more dedicated hardware logic circuits. Alternatively, the controller and its method described in relation to the present disclosure may be implemented by one or more dedicated computers that are formed by a combination of a processor and a memory programmed to execute one or more functions and one or more hardware logic circuits. The computer program may be stored as instructions to be executed by a computer in a computer-readable non-transitory tangible recording medium.

What is claimed is:

1. An on-board device for a vehicle, comprising:
an unavailability location determination unit configured to determine whether an area around where the vehicle is traveling is
an autonomous driving unavailable location; and
a transmission control unit configured to cause the on-board device to transmit to a server a result of determination made by the unavailability location determination unit.

2. The on-board device according to claim 1, further comprising
a reason-for-unavailability recording unit configured to, in response to the unavailability location determination unit determining that the area around where the vehicle is traveling is an autonomous driving unavailable location, record the area as an autonomous driving unavailable location in association with a reason for unavailability.

3. The on-board device according to claim 2, wherein
the transmission control unit is configured to cause the on-board device to transmit to the server the reason for unavailability recorded by the reason-for-unavailability recording unit.

4. The on-board device according to claim 1, wherein
the transmission control unit is configured to cause the on-board device to transmit to the server unavailability determination information which is determination information that was used by the unavailability location determination unit to determine that the area around where the vehicle is traveling is an autonomous driving unavailable location.

5. The on-board device according to claim 1, further comprising:
a removal-of-unavailability determination unit configured to determine whether unavailability of autonomous driving has been removed at the autonomous driving unavailable location; and
a reason-for-removal recording unit configured to, in response to the removal-of-unavailability determination unit determining that unavailability of autonomous driving has been removed at the autonomous driving unavailable location, record the location where unavailability of autonomous driving has been removed, in association with a reason for removal.

6. The on-board device according to claim 5, wherein
the transmission control unit is configured to cause the on-board device to transmit to the server the reason for removal recorded by the reason-for-removal recording unit.

7. The on-board device according to claim 5, wherein
the transmission control unit is configured to cause the on-board device to transmit to the server removal determination information which is determination information that was used by the removal-of-unavailability determination unit to determine that unavailability of autonomous driving has been removed at the autonomous driving unavailable location.

8. The on-board device according to claim 5, wherein
the unavailability location determination unit is configured to use surroundings-of-vehicle information to determine whether the area around where the vehicle is traveling is an autonomous driving unavailable location, and
the removal-of-unavailability determination unit is configured to use the surroundings-of-vehicle information to determine whether unavailability of autonomous driving has been removed at the autonomous driving unavailable location.

9. The on-board device according to claim 1, further comprising:
a map data storage unit configured to store map data;
a presence-of-unavailability-zone determination unit configured to use forward information of a travel route included in the map data stored in the map data storage unit to determine whether there is an autonomous driving unavailable zone ahead of the vehicle;
a cause information acquisition unit configured to, in response to the presence-of-unavailability-zone determination unit determining that there is an autonomous driving unavailable zone ahead of the vehicle, acquire cause information of unavailability of autonomous driving included in the map data stored in the map data storage unit;
a presence-of-cause determination unit configured to use surroundings-of-vehicle information to determine whether a cause of unavailability of autonomous driving indicated by the cause information of unavailability of autonomous driving acquired by the cause information acquisition unit persists,
wherein the transmission control unit is configured to cause the on-board device to transmit to the server a result of determination made by the presence-of-cause determination unit.

10. The on-board device according to claim 9, wherein
the transmission control unit is configured to cause the on-board device to transmit to the server presence-of-cause determination information that was used by the presence-of-cause determination unit to determine that the cause of unavailability of autonomous driving persists.

11. The on-board device according to claim 9, further comprising:
an autonomous driving availability determination unit configured to, in response to the presence-of-unavailability-zone determination unit determining that there is an autonomous driving unavailable zone ahead of the vehicle, determine whether autonomous driving is available, based on the cause information of unavailability of autonomous driving acquired by the cause information acquisition unit and vehicle equipment of the vehicle; and
a control performance unit configured to, in response to the autonomous driving availability determination unit determining that autonomous driving is unavailable, perform vehicle driving control.

12. A server comprising:
a notification information acquisition unit configured to acquire, from an on-board device for a vehicle, a result of determination made by the on-board device that an area around where the vehicle is traveling is an autonomous driving unavailable location, as unavailability notification information; and
a notification information recording unit configured to record the unavailability notification information acquired by the notification information acquisition unit.

13. The server according to claim 12, wherein
the notification information acquisition unit is configured to acquire, from the on-board device, a result of determination made by the on-board device that unavailability of autonomous driving has been removed at the autonomous driving unavailable location, as removal notification information, and
the notification information recording unit is configured to record the removal notification information acquired by the notification information acquisition unit.

14. An autonomous driving availability determination system comprising:
an on-board device for a vehicle, configured to determine whether an area around where the vehicle is traveling is an autonomous driving unavailable location, and transmit to a server a result of determination that the area around where the vehicle is traveling is an autonomous driving unavailable location, as unavailability notification information; and
the server configured to receive the unavailability notification information transmitted from the on-board device and record the received unavailability notification information.

15. The autonomous driving availability determination system according to claim 14, wherein
the on-board device is configured to transmit to the server a result of determination that unavailability of autonomous driving has been removed at the autonomous driving unavailable location, as removal notification information, and
the server is configured to receive the removal notification information transmitted from the on-board device and record the received removal notification information.

16. An autonomous driving availability determination method comprising:
a control unit incorporated in an on-board device for a vehicle determining whether an area around where the vehicle is traveling is an autonomous driving unavailable location; and
the control unit causing the on-board device to transmit to a server a result of determination as to whether the area around where the vehicle is traveling is an autonomous driving unavailable location.
